(19) United States
(12) Patent Application Publication
(10) Pub. No.: US 2006/0094612 A1
(43) Pub. Date: May 4, 2006

(54) Post etch cleaning composition for use with substrates having aluminum

(76) Inventor: Mayumi Kimura, Kawasaki (JP)

Correspondence Address: MORGAN LEWIS & BOCKIUS LLP, 1111 PENNSYLVANIA AVENUE NW, WASHINGTON, DC, 20004, US

(21) Appl. No.: 10/980,247

(22) Filed: Nov. 4, 2004

(51) Int. Cl. C11D 7/32

(52) U.S. Cl. 510/175

(57) ABSTRACT

A composition used for removing a photoresist, polymeric material, or residue from a substrate contains a corrosion inhibitor that is a derivative of gallic acid that is soluble in water-miscible organic solvents, water, at least one organic amine, and two or more water-miscible organic solvents. The composition may further contain a surfactant. Use of this composition reduces resist reattachment, reduces corrosion, and improves peelability.

### FIELD OF THE INVENTION

This application relates to a composition, and a method of using the composition, to remove a photoresist or other polymeric material and/or residue from a substrate after etching or ashing during an integrated circuit manufacturing process, particularly during the aluminum wiring process, that reduces peeling and corrosion of the wiring.

### BACKGROUND OF THE INVENTION

During a process for manufacturing highly integrated semiconductor elements, a resist is usually coated on the material of an interlayer insulating film, etc., used for achieving insulation between wirings or metal films used as electroconductive wiring materials. After a desired resist pattern is formed, drying is performed, with the resist film used as a mask. The remaining resist film is then removed. The resist film can be removed directly by using a washing solution or by means of wet processing, which performs plasma ashing first, then uses a washing solution to remove the resist residue left on the wiring material or the interlayer insulating film. In recent years, accompanying the development of fine semiconductor elements, it is required to further reduce the damages to the metal film made of wiring material. Also, since the devices used for washing are diversified, it is required to develop a composition that can be used flexibly in various methods.

Aluminum-type material is usually used as the aforementioned wiring material. In this case, examples of the washing solution that can be used include solvent amine-type washing solutions (such as patent reference 1), washing solutions containing a hydroxylamine (such as patent references 2-3), and solvent amine-type washing solutions containing a corrosion inhibitor (such as patent reference 4).

In the following, the problems of using the conventional washing solution will be described below.

When using the solvent amine-type washing solution disclosed in patent reference 1, U.S. Pat. No. 4,617,251 assigned on its face to Olin Hunt, the resist peeling capability is sufficient. However, the peeling force for the resist residue after plasma ashing is not high enough. In addition, since no corrosion inhibitor is added, the aluminum wiring will be partially corroded when it is directly rinsed with water.

A hydroxylamine-organic amine-catechol peeling solution was disclosed in patent reference 2, U.S. Pat. No. 5,911,835 assigned to EKC Technology. This washing solution can remove resist residue after etching and ashing. However, although the corrosion inhibitor used for this washing solution can inhibit the corrosion of aluminum, the aluminum etching rate will increase significantly if water rinsing is carried out without using an intermediate rinsing operation. As a result, partial corrosion of aluminum will occur. In addition, it is pointed out that catechol used as the corrosion inhibitor is a governmentally regulated material.

A peeling solution using a gallate was disclosed in patent reference 3 U.S. Pat. No. 6,187,730 assigned to EKC Technology. It, however, is used to improve the Ti corrosion-inhibiting effect. Also, since an intermediate rinsing operation is included, the solution cannot be used flexibly for various methods.

A peeling solution using a gallate was disclosed in patent reference 4, U.S. Pat. No. 5,988,186 assigned on its face to Ashland. However, the characteristics of the solution, including the peeling capability, are not sufficient.

In addition, when the general organic amine-based alkaline washing solution is mixed with water, corrosion of aluminum will be significantly worsened. Also, the resist dissolved in the washing solution will become a microgel during water rinsing, to attach again. Therefore, processing using an intermediate rinsing solution, such as isopropanol or N-methylpyrrolidone, is needed. As a result, the amount of the chemical solution used and the semiconductor manufacturing steps will be increased.

### SUMMARY OF THE INVENTION

One objective of the present invention is to provide a composition for an amine-type washing solution and a washing method suitable for a semiconductor process for removing a photoresist or other polymeric material or residue from a substrate after etching or ashing in a semiconductor manufacturing process, such as the current aluminum wiring process.

Another objective of the present invention is to provide a composition and a washing method that can prevent the partial corrosion of aluminum used as wiring material and reattachment of the resist occurring during rinsing with an amine-type washing solution. Also, the present invention tries to make it possible to omit the intermediate rinsing operation used after the processing of the amine-type washing solution and to provide a composition and a washing method that can be used flexibly in various processes, with little limitation on the method of use.

In addition, the present invention tries to provide a washing solution that does not require a corrosion inhibitors that is a governmentally regulated material.

In order to realize the aforementioned objectives, the present invention provides a composition comprised of a corrosion inhibitor that can be mixed with a water-soluble organic solvent, water, at least one organic amine, and two or more water-soluble organic solvents, or a composition prepared by adding a surfactant into the aforementioned composition, as well as the corresponding washing method. By using such a composition and washing method, the corrosion resistance of the material can be improved while the desired peeling capability can be retained. Also, the balance between the peeling property and corrosion resistance can be improved by combining water-soluble organic solvents. In addition, by using the corrosion inhibitor mentioned in the present invention, corrosion of aluminum used as wiring material occurring during water rinsing can be significantly reduced. Reattachment of the resist can also be suppressed by adopting the proper surfactant. Moreover, depending on the effects of these compositions, it is possible to maintain the desired washing performance even if the intermediate rinsing operation used after the processing of the amine-type washing solution is omitted, and the composition can be used flexibly in various methods.

A composition comprising 1) a corrosion inhibitor that can be mixed with a water-soluble organic solvent, 2) water, 3) at least one organic amine, and 4) two or more water-soluble organic solvents, is used to remove a photoresist or other polymeric material or post-ash or post-etch residue from a substrate, the photoresist or residue can be removed, and the wiring material is protected against corrosion. It is also possible to prevent the corrosion of aluminum when the substrate is rinsed using the conventional amine-type peeling solution. As a result, the intermediate rinsing operation can be omitted, and the method of use can be diversified.

### BRIEF DESCRIPTION OF THE FIGURE

FIG. 1 is a graph of aluminum thickness loss, as a function of the amount of water present, when a substrate is cleaned with compositions of this inventioon compared to when a substrate is cleaned using prior art compositions.

### DETAILED DESCRIPTION OF PREFERRED EMBODIMENTS

The present invention pertains to a washing solution and a washing method used for peeling off and removing a photoresist film or other polymeric material or residues left after dry etching during the process of forming metal wiring or interconnect on a semiconductor substrate.

The present invention pertains to a composition, which is used to peel off and remove a resist film, resist residues, and other reaction residues (etching residues) formed with etching gas left after dry etching during the process of forcing metal wiring, mainly composed of aluminum on a semiconductor substrate, and to a washing method using the aforementioned composition.

Since the corrosion inhibitor used in the present invention can also be used as a food additive, it is possible to provide a safe and environmentally friendly peeling solution. Also, since the intermediate rinsing operation using an organic solvent can be omitted, the amount of the organic solvent used can be reduced, and the composition becomes environmentally friendly.

In the following, the present invention will be explained in detail.

In order to solve the problems occurring when using the conventional peeling agents, the present inventors have performed extensive research. As a result of this research, it was found that the aforementioned problems can be solved by using a composition comprised of a corrosion inhibitor, water, an organic amine, two or more water-soluble organic solvents, and optionally a surfactant. The present invention was achieved based on the aforementioned research. In other words, the present invention provides a peeling agent composition for a resist, characterized by being an aqueous solution containing a corrosion inhibitor, water, organic amine, two or more types of organic solvents, and surfactant.

The corrosion inhibitor that can be used in the present invention is propyl gallate. When this corrosion inhibitor is used, corrosion of aluminum can be significantly reduced when diluted with water. This characteristic is not limited to propyl gallate. It is a common feature of all gallic acid type compounds. However, propyl gallate is a common product that can be dissolved in both an alkaline aqueous solution and water-soluble organic solvent, and can be used easily. When using gallic acid or other corrosion inhibitor that is difficult to dissolve in a water-soluble organic solvent, the corrosion inhibitor may be gelled and precipitated during use.

Organic amines that can be used in the present invention include primary, secondary, and tertiary aliphatic amines, alicyclic amines, aromatic amines, heterorcyclic amines, or other organic amines, lower alkyl quaternary ammonium bases, etc., that can be mixed with water-soluble solvents. The most preferred amine is an alkanolamine, which is selected from monoamine, diamine, and triamine having 1-5 carbon atoms. Examples of appropriate alkanolamines include monoethanolamine, diethanolamine, triethanolamine, isopropanolamine, diisopropanolamine, 2-amine-1-propanol, 3-amino-1-propanol, isobutanolamine, diglycolamine (2-amino-2-ethoxyethanol), and 2-amino-2-ethoxypropanol, and the like.

Examples of alicyclic amines include cyclohexyl amine, dicyclohexyl amine, etc.

Examples of heterocyclic amines include pyrrole, pyrrolidine, pyridine, morpholine, pyrazine, piperidine, oxazole, triazole, imidazole, furan, and the like.

Examples of lower alkyl quaternary ammonium bases include tetramethyl ammonium hydroxide, (2-hydroxyethyl) trimethyl ammonium hydroxide, bis(2-hydroxyethyl) dimethyl ammonium hydroxide, tris(2-hydroxyethyl) methyl ammonium hydroxide, and the like.

Hydroxylamine compounds can also be used for this composition. Hydroxylamine compounds are commonly used for peeling solution in combination with an organic amine. If the residues derived from the photoresist contains many Ti-based residues, using a hydroxylamine compound in combination with the aforementioned organic amine can further the peeling capability.

Hydroxylamine compounds suitable for use in the composition are represented by the following formula:

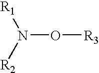

wherein R1, R2, and R3 are independently hydrogen; optionally a substituted C1-C6 straight, branched or cyclo alkyl, alkenyl, or alkynyl group; optionally a substituted acyl group, straight or branched alkoxy group, amidyl group, carboxyl group, alkoxyalkyl group, alkylamino group, alkylsulfonyl group, or sulfonic acid group, or the salt of such compounds. Derivatives of these compounds, for example the amides of the above described, are also suitable for use.

The preferred hydroxylamine compound that can be used in the present invention is hydroxylamine, having a H₂N—OH structure, and is usually supplied by BASF as a 50% aqueous solution. The hydroxylamine in this commercially available form was used in some examples of the present invention.

Examples of the preferred water-soluble organic solvents that can be used in the present invention include N,N-dimethylacetamide, N,N-dimethylformamide, N,N-diethylacetamide, N,N-diethylformamide, N-methylacetamide, N-methylformamide, and other amides, N-methyl-2-pyrrolidone, N-ethyl-2-pyrrolidone, N-hydroxyethyl-2-pyrrolidone, and other pyrrolidones, 1,3-dimethyl-2-imidazolidinone, 1,3-diethyl-2-imidazolidinone, and other imidazolidinones, ethylene glycol, ethylene glycol monomethyl ether, ethylene glycol monoethyl ether, ethylene glycol monobutyl ether, ethylene glycol monomethyl ether acetate, ethylene glycol monoethyl ether acetate, diethylene glycol, diethylene glycol monomethyl ether, diethylene glycol monoethyl ether, diethylene glycol monobutyl ether, triethylene glycol monomethyl ether, propylene glycol, propylene glycol monomethyl ether, propylene glycol monoethyl ether, propylene glycol monobutyl ether, dipropylene glycol monomethyl ether, dipropylene glycol monoethyl ether, dipropylene glycol monobutyl ether, diethylene glycol dimethyl ether, diethylene glycol monoethyl ether, diethylene glycol dibutyl ether, dipropylene glycol dimethyl ether, dipropylene glycol diethyl ether, dipropylene glycol dibutyl ether, tripropylene glycol dimethyl ether, and other glycol ethers, and their derivatives, γ-butyrolactone, σ-valerolactone, and other lactones, methyl lactate, ethyl lactate, propyl lactate, and other oxycarboxylic acid derivatives, 3-methyl-2-oxazolidinone, 3-ethyle-2-oxazolidinone, and other oxazolidinones, etc. Among them, the combination of a glycol ether with a high peeling capability and a sulfoxide with a high corrosion inhibiting effect is preferred.

The surfactant used in the present invention can be selected from cationic surfactants, anionic surfactants, nonionic surfactants, and betaine. The most preferred surfactant is a nonionic surfactant. A surfactant that is soluble in both water and water-soluble solvents is selected. Also, in consideration of viscosity, foaming, or other handling property, it is preferred to use a secondary alcohol type of nonionic surfactant.

The aforementioned composition is comprised of from about 0.01 to about 10% of a corrosion inhibitor, from about 2.5 to about 40% of an organic amine, from about 5 to about 90% of water, from about 5 to about 70% of a water-soluble solvent, and 0 to about 2% of a surfactant. More preferably, the composition is comprised of from about 2 to about 6% of a corrosion inhibitor, from about 10 to about 25% of an organic amine, from about 10 to about 25% of water, from about 30 to about 70% of a mixture of two or more types of water-soluble organic solvents in any proportions, and from about 0.1 to about 0.6% of a surfactant.

According to the present invention, the rinsing operation can be carried out without using an intermediate rinsing operation.

Of course, it is also possible to carry out intermediate rinsing, using compositions comprising isopropanol, N-methylpyrrolidone or other organic solvents depending on the process and the device used.

### EXAMPLES

In the following, the present invention will be explained in more detail with reference to application examples.

In the method of using the composition of the present invention to wash a substrate, the substrate having a photoresist and other polymeric materials or residues is brought into contact with the composition of the present invention at an appropriate temperature for a period of time that is long enough to remove the residues. The aforementioned substrate is usually immersed in the washing solution composition of the present invention. The time and temperature can vary, as long as the residues are removed from the substrate. In general, the temperature is in the range of room temperature to 100° C., and the contact time is in the range of about 1 to about 60 min. The substrate is then washed with purified water and is then dried.

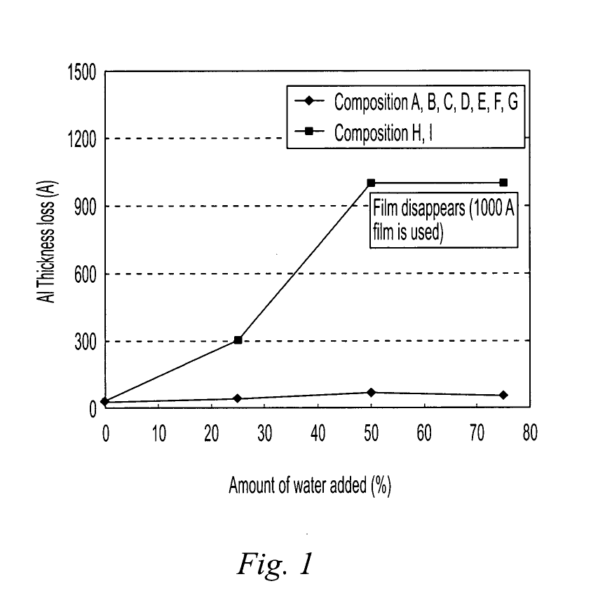

Measurement of thickness of aluminum film: The thickness of the aluminum film was measured with a fluorescent X-ray analytical device (Philips PW2800). The thickness of the aluminum film used was 1000 Å. The results are summarized in FIG. 1. After the sample substrate was immersed in the composition at 60° C. for 10 min, the substrate was rinsed with deionized water and dried in nitrogen gas.

Peeling of residues after the washing and the damage to aluminum were observed using SEM based on the standards described below.

Preparation of Sample: A sample substrate was prepared as an aluminum alloy circuit element. First, a silicon oxide film was formed by means of thermal oxidation on a silicon substrate. Titanium nitride (TiN) as a barrier metal, aluminum (Al/Cu) wiring, and titanium nitride as a barrier metal on the aluminum wiring were then formed by means of magnetron sputtering. After that, a resist was coated by means of spin coating, followed by exposure and development to form a resist pattern. With the resist pattern used as a mask, BCl₃/Cl₂ gas was used to perform dry etching (-> sample 1 sample to evaluate peeling of the resist). Subsequently, oxygen plasma ashing was carried out at 250° C. on the remaining resist pattern using a parallel plate type of RIE device. For the substrate obtained after ashing, resist residues were left on the sidewall of the pattern and on the top TiN (sample 2→ sample for evaluating peeling of polymer).

Compositions A-M used as peeling agent compositions for the resist residue were prepared according to Table 1. The unit was wt %. After a sample substrate was immersed in the compositions prepared according to Table 1 at 60° C. for 10 min, the substrate was rinsed with super pure water and dried in nitrogen gas. The peeling property of the obtained sample substrate was evaluated as shown in Table 2. Also, the corrosion of aluminum was observed when an intermediate rinsing using isopropanol was performed, or not performed, after the sample substrate was immersed in the composition and before it was washed with super pure water. The results are shown in Table 3. For the sample substrates obtained after the processing, the resist residue and the corrosion state of the surface of aluminum alloy wiring were evaluated using a scanning electron microscope (SEM). The resist peeling property and corrosiveness were evaluated based on the following standards.

Peeling property:

⊚: Residues were completely removed;

Δ: Part of the residues remained.

X: Most of the residues remained.

Corrosion

⊚: No partial corrosion of aluminum was observed.

Δ: Partial corrosion of aluminum was observed.

X: Severe partial corrosion of aluminum was observed.

Evaluation of reattachment of resist: To evaluate attachment of the washing solution after the resist was peeled off, the washing solution obtained after the resist was dissolved was added forcibly into super pure water, following by spin drying without using a super-pure-water rinsing stage. The amount of the increased particles on the wafer was measured by a foreign-matter detection device KLA-tencor SP1. The results are shown in Table 4. Reattachment of resist was evaluated based on the following standards.

Reattachment

⊚: No reattachment

Δ: Reattachment occurred in some areas

X: Reattachment [fully] occurred

In the following, the present invention will be explained in more detail with reference to application examples. The present invention, however, is not limited to these application examples. For the composition of the present invention, the capability of removing the resist residue after dry etching, the capability of removing residue remaining after ashing, and the anti-corrosion effect with respect to the aluminum film were evaluated as follows.

The present invention is described with reference to the following experiment. Also, examples of the peeling compositions suitable for removing the photoresist and other organic residues from the substrate are listed in Table 1.

Compositions A-G are the application examples of the present invention, while compositions H-M are conventional prior art chemical solutions used as comparative examples.

HA in Table 1 indicates hydroxylamine, which is reported as the commercially available 50% aqueous solution. Therefore, if a composition contains HA, it also contains water. For a composition using HA, as far as the water content in Table 1 is concerned, the value in ( ) (parentheses) indicates the total content of water including that from the 50% HA. Compositions containing surfactant were prepared by combining all components except surfactant to prepare a solution of 100 weight percent, then adding the specified amount of surfactant.

TABLE 1

| | | | | | Water-soluble | | |
|---|---|---|---|---|---|---|---|
| | | Corrosion | Organic | | organic | | |
| | | inhibitor | amine | Water | solvent | Surfactant | 50% HA |
| Application | Composition A | GAP 3% | MIPA 20% | 20% | DGBE 37% | 0% | 0% |
| Example 1 | | | | | DMSO 20% | | |
| Application | Composition B | GAP 5% | MEA 18% | 20% | DGBE 37% | Polyoxyethylene | 0% |
| Example 2 | | | | | DMSO 20% | alkyl ether | |
| | | | | | | 0.4% | |
| Application | Composition C | GAP 1% | DGA 22% | 20% | DGBE 47% | Polyoxyethylene | 0% |
| Example 3 | | | | | DMSO 10% | alkyl ether | |
| | | | | | | 0.1% | |
| Application | Composition D | GAP 3% | MEA 10% | 20% | DGBE 20% | 0□ | 0% |
| Example 4 | | | | | DMSO 47% | | |
| Application | Composition E | GAP 5% | DGA 10% | 20% | DGBE 25% | Polyoxyethylene | 15% |
| Example 5 | | | | 27.5% | DMSO 25% | alkyl ether | |
| | | | | | | 0.5% | |
| Application | Composition F | GAP 5% | DGA 10% | 20% | DGBE 25% | 0% | 15% |
| Example 6 | | | | 27.5% | DMSO 25% | | |
| Application | Composition G | GAP 3% | MIPA 15% | 0% | DGBE 25% | 0% | 35% |
| Example 7 | | | | 17.5% | DMSO 22% | | |
| Comparative | Composition H | Catechol | DGA 60% | 0% | 0% | 0% | 35% |
| Example 1 | | 5% | | 17.5% | | | |
| Comparative | Composition I | Catechol | MEA 30% | 0% | 0% | 0% | 30% |
| Example 2 | | 10% | MIPA 30% | 15% | | | |
| Comparative | Composition J | 0% | DGA 50% | 0% | NMP 50% | 0% | 0% |
| Example 3 | | | | | | | |
| Comparative | Composition K | 0% | 0% | 0% | NMP 100% | 0% | 0% |
| Example 4 | | | | | | | |
| Comparative | Composition L | GAP 2% | MIPA 20% | 25% | DGBE 53 | 0% | 0% |
| Example 5 | | | | | | | |
| Comparative | Composition M | GAP 1% | MEA 60% | 9% | DMSO 30 | 0% | 0% |
| Example 6 | | | | | | | |

GAP: Propyl gallate
MEA: Monoethanolamine
MIPA: Monoisopropanolamine
PGME: Propylene glycol monomethyl ether
DMSO: Dimethyl sulfoxide
HA: Hydroxylamine
GA: Gallic acid
DGA: Diglycolamine
DGBE: Diethylene glycol monobutyl ether
NMP: N-methyl pyrrolidone

### Example 1

In this application example, the influences of propyl gallate and catechol used as corrosion inhibitors on aluminum upon dilution with water were investigated by comparing compositions A-G (corrosion inhibitor: propyl gallate) and compositions H, I (corrosion inhibitor: catechol). Typical results are shown in FIG. 1. The corrosion amount of aluminum upon dilution with water was significantly reduced by using the corrosion inhibitor in the present invention.

The ordinate in FIG. 1 represents the loss amount of aluminum, which is equivalent to the corrosion amount. The larger the loss amount of aluminum, the more severe the corrosion. Also, the abscissa shows the proportion of water added into the composition. It is assumed that the composition is diluted during water rinsing. If the loss increases sharply along with the increase in the water proportion, it means that partial corrosion of aluminum tends to occur, and intermediate rinsing is required.

Example 2

In this embodiment, the peeling property of the processing substrate with respect to the composition of the present invention is shown in Table 2. The partial corrosiveness of aluminum when intermediate rinsing was performed, or not performed, between peeling processing and water rinsing is shown in Table 3. By using the composition of the present invention, the aluminum corrosion resistance can be improved, while maintaining the peeling property. These results indicate that the composition can be used flexibly in various methods.

TABLE 2
Peeling property

| | | | | | Water- | | | | |
|---|---|---|---|---|---|---|---|---|---|
| | | | | | soluble | | | | |
| | | Corrosion | Organic | | organic | | | Peeling property | |
| | | inhibitor | amine | Water | solvent | Surfactant | 50% HA | Sample 1 | Sample 2 |
| Application | Composition A | GAP 3% | MIPA | 20% | DGBE 37% | 0% | 0% | ⊚ | ⊚ |
| Example 1 | | | 20% | | DMSO | | | | |
| | | | | | 20% | | | | |
| Application | Composition B | GAP 5% | MEA | 20% | DGBE 37% | Polyoxyethylene | 0% | ⊚ | ⊚ |
| Example 2 | | | 18% | | DMSO 20% | alkyl ether | | | |
| | | | | | | 0.4% | | | |
| Application | Composition C | GAP 1% | DGA | 20% | DGBE 47% | Polyoxyethylene | 0% | ⊚ | ⊚ |
| Example 3 | | | 22% | | DMSO 10% | alkyl ether | | | |
| | | | | | | 0.1% | | | |
| Application | Composition D | GAP 3% | MEA | 20% | DGBE 20% | 0% | 0% | ⊚ | ⊚ |
| Example 4 | | | 10% | | DMSO 47% | | | | |
| Comparison | Composition J | 0% | DGA | 0% | NMP 50% | 0% | 0% | ⊚ | X |
| Example 3 | | | 50% | | | | | | |
| Comparison | Composition K | 0% | 0% | 0% | NMP 100% | 0% | 0% | ⊚ | X |
| Example 4 | | | | | | | | | |
| Comparison | Composition M | GAP 1% | MEA | 9% | DMSO 30 | 0% | 0% | ⊚ | Δ |
| Example 6 | | | 60% | | | | | | |

TABLE 3
Partial corrosiveness of aluminum, depending on whether intermediate rinsing
is performed

| | | | | | Water- | | | Partial corrosiveness of A1 | |
|---|---|---|---|---|---|---|---|---|---|
| | | | | | soluble | | | Intermediate | Intermediate |
| | | Corrosion | Organic | | organic | | 50% | rinsing is | rinsing is not |
| | | inhibitor | amine | Water | solvent | Surfactant | HA | performed | performed |
| Application | Composition A | GAP 3% | MIPA | 20% | DGBE 37% | 0% | 0% | ⊚ | ⊚ |
| Example 1 | | | 20% | | DMSO 20% | | | | |
| Application | Composition B | GAP 5% | MEA 18% | 20% | DGBE 37% | Polyoxyethylene | 0% | ⊚ | ⊚ |
| Example 2 | | | | | DMSO 20% | alkyl ether | | | |
| | | | | | | 0.4% | | | |
| Application | Composition C | GAP 1% | DGA 22% | 20% | DGBE 47% | Polyoxyethylene | 0% | ⊚ | ⊚ |
| Example 3 | | | | | DMSO 10% | alkyl ether | | | |
| | | | | | | 0.1% | | | |
| Application | Composition D | GAP 3% | MEA 10% | 20% | DGBE 20% | 0 | 0% | ⊚ | ⊚ |
| Example 4 | | | | | DMSO 47% | | | | |
| Application | Composition E | GAP 5% | DGA 10% | 20% | DGBE 25% | Polyoxyethylene | 15% | ⊚ | ⊚ |
| Example 5 | | | | (27.5%) | DMSO 25% | alkyl ether | | | |
| | | | | | | 0.5% | | | |
| Application | Composition F | GAP 5% | DGA 10% | 20% | DGBE 25% | 0% | 15% | ⊚ | ⊚ |
| Example 6 | | | | (27.5%) | DMSO 25% | | | | |
| Application | Composition G | GAP 3% | MIPA | 0% | DGBE 25% | 0% | 35% | ⊚ | ⊚ |
| Example 7 | | | 15% | (17.5%) | DMSO 22% | | | | |
| Comparison | Composition H | Catechol | DGA 60% | 0% | 0% | 0% | 35% | ⊚ | X |
| Example 1 | | 5% | | (17.5%) | | | | | |
| Comparison | Composition I | Catechol | MEA 30% | 0% | 0% | 0% | 30% | ⊚ | X |
| Example 2 | | 10% | MIPA | 15% | | | | | |
| | | | 30% | | | | | | |
| Comparison | Composition J | 0% | DGA | 0% | NMP 50% | 0% | 0% | ⊚ | X |
| Example 3 | | | 50% | | | | | | |
| Comparison | Composition L | GAP 1% | MEA 20% | 35% | DGBE 54 | 0% | 0% | ⊚ | Δ |
| Example 5 | | | | | | | | | |

### Example 3

Reattachment of the resist may occur if no intermediate rinsing is performed for the peeling solution obtained after the resist is peeled off. In this application example, the reattachment-inhibiting effect realized by adding a surfactant was evaluated. The results are listed in Table 4. Reattachment of the resist can be significantly reduced by adding a surfactant into the composition of the present invention.

TABLE 4
Reattachment of resist

| | | | | | Water- | | | |
|---|---|---|---|---|---|---|---|---|
| | | | | | soluble | | | |
| | | Corrosion | Organic | | organic | | | Reattachment |
| | | inhibitor | amine | Water | solvent | Surfactant | 50% HA | of the resist |
| Application | Composition A | GAP 3% | MIPA 20% | 20% | DGBE 37% | 0% | 0% | X |
| Example 1 | | | | | DMSO 20% | | | |
| Application | Composition B | GAP 5% | MEA 18% | 20% | DGBE 37% | Polyoxyethylene | 0% | ⊚ |
| Example 2 | | | | | DMSO 20% | alkyl ether 0.4% | | |
| Application | Composition C | GAP 1% | DGA 22% | 20% | DGBE 47% | Polyoxyethylene | 0% | ⊚ |
| Example 3 | | | | | DMSO 10% | alkyl ether 0.1% | | |
| Application | Composition D | GAP 3% | MEA 10% | 20% | DGBE 20% | 0 | 0% | X |
| Example 4 | | | | | DMSO 47% | | | |
| Application | Composition E | GAP 5% | DGA 10% | 20% | DGBE 25% | Polyoxyethylene | 15% | ⊚ |
| Example 5 | | | | □27.5%□ | DMSO 25% | alkyl ether 0.5% | | |
| Application | Composition F | GAP 5% | DGA 10% | 20% | DGBE | 0% | 15% | X |
| Example 6 | | | | □27.5%□ | 25% | | | |
| | | | | | DMSO 25% | | | |

### RESULTS OF THE INVENTION

By using the composition of the present invention, a balance among the washing characteristics can be improved, and the intermediate rinsing operation carried out after the processing using an amine-type washing solution can be omitted. The present invention provides a composition and a washing method that can be used flexibly for various processes, with little limitation on the method of use.

What is claimed is:

1. A composition used for removing a photoresist, polymeric material, or residue from a substrate comprising a corrosion inhibitor that is a derivative of gallic acid that is soluble in water-miscible organic solvents, water, at least one organic amine, and two or more water-miscible organic solvents.

2. The composition of claim 1, wherein the corrosion inhibitor is propyl gallate.

3. The composition of claim 1, wherein the corrosion inhibitor comprises from about 0.01 to about 10% by weight propyl gallate.

4. The composition of claim 1, wherein the corrosion inhibitor comprises from about 2 to about 6% by weight propyl gallate.

5. The composition of claim 1, wherein the at least one organic amine is an alkanolamine.

6. The composition of claim 1, wherein the at least one organic amine is a monoamine, diamine, or triamine having hydroxyl groups with 1-5 carbon atoms.

7. The composition of claim 1, wherein the at least one organic amine is selected from the group consisting of monoethanolamine, diglycolamine, and isopropanolamine.

8. The composition of claim 1, wherein the at least one organic amine ranges from about 2.5 to about 40% by weight.

9. The composition of claim 1, wherein at least one of the two or more water-miscible organic solvents is selected from the group consisting of glycol ethers, sulfoxides, amides, pyrrolidones, lactones, and derivatives of oxycarboxylic acids.

10. The composition of claim 1, wherein the two or more water-miscible organic solvents comprise a mixture of glycol ethers and sulfoxides.

11. The composition of claim 1, wherein the two or more water-miscible organic solvents comprise a mixture of diethylene glycol monobutyl ether and dimethyl sulfoxide.

12. The composition of claim 1, wherein the two or more water-miscible organic solvents comprise a mixture of from about 5 to about 70% by weight diethylene glycol monobutyl ether and from about 5 to about 70% by weight dimethyl sulfoxide.

13. The composition of claim 1, wherein the water is from about 5 to about 90% by weight.

14. A composition used for removing a photoresist or other polymeric material or residue from a substrate comprising a corrosion inhibitor that is a derivative of gallic acid that is soluble in water-miscible organic solvents, water, at least one organic amine, two or more water-miscible organic solvents, and a surfactant.

15. The composition of claim 14, wherein the surfactant is selected from the group consisting of cationic surfactants, anionic surfactants, nonionic surfactants, and betaine.

16. The composition of claim 14, wherein the surfactant is a nonionic surfactant.

17. The composition of claim 14, wherein the surfactant is a nonionic surfactant of from about 0.01 to about 2% by weight.

18. The composition of claims 14, wherein the surfactant is miscible with water and water-soluble organic solvents.

19. The composition of claim 1, further comprising a hydroxylamine compound.

20. The composition of claim 1, further comprising hydroxylamine.

21. The composition described in claim 1, characterized by the fact that the composition contains no component that is gelled even if water is evaporated during use.

22. The composition described in claim 2, characterized by the fact that the composition contains no component that is gelled even if water is evaporated during use.

23. The composition described in claim 14, characterized by the fact that the composition contains no component that is gelled even if water is evaporated during use.

24. The composition described in claims 15, characterized by the fact that the composition contains no component that is gelled even if water is evaporated during use.

25. The composition described in claim 1, characterized by the fact that the substances used for this composition contain no component that can be gelled even if water is evaporated during use.

25. The composition described in claim 14, characterized by the fact that the substances used for this composition contain no component that can be gelled even if water is evaporated during use.

26. A method for removing photoresist or other polymeric material or residue from a substrate comprising contacting the composition of claim 1 with the substrate.

27. The method of claim 21, further comprising a water rinsing operation without using an intermediate rinsing operation.
